(19) United States
(12) Patent Application Publication
(10) Pub. No.: US 2004/0144723 A1
(43) Pub. Date: Jul. 29, 2004

(54) Method and device for providing a fuel

(76) Inventors: Markus Gloeckle, Stuttgart (DE); Markus Hernier, Stuttgart (DE)

Correspondence Address: KENYON & KENYON, ONE BROADWAY, NEW YORK, NY, 10004, US

(21) Appl. No.: 10/725,858

(22) Filed: Dec. 1, 2003

(30) Foreign Application Priority Data
Nov. 29, 2002 (DE) 10255778.0
Aug. 8, 2003 (DE) 10336759.4

(51) Int. Cl. B01D 61/00

(52) U.S. Cl. 210/640; 210/650; 210/321.6

(57) ABSTRACT

A method and a device for supplying a fuel, in particular for operating combustion engines in motor vehicles, turbines or the like, the fuel being split at a separation means into a first fuel fraction in the form of a retentate and into a second fuel fraction in the form of a permeate. On the permeate side, the separation means is acted upon by a scavenging gas, so that a mixture of the fuel permeate and the scavenging gas is produced.

### BACKGROUND INFORMATION

Within the framework of ongoing efforts to minimize the emission of environmentally harmful substances in the operation of internal combustion engines, the reduction of particles and nitrogen oxides released by engines, in particular in connection with diesel engines, is the focus of intensive research. Both groups of pollutants can ultimately be traced back to heterogeneous mixture constituents of the combustion mixture present in the combustion chamber of an engine. To a large degree, these inhomogeneities are caused by the fuel being injected into the combustion chamber in liquid form, and they are directly related to the different evaporation characteristics (such as different boiling points) or to the different ignition performances of the various fuel components. In diesel fuels, it is especially the aromatic fuel components it contains that are distinguished by high boiling points and low ignition performance.

From U.S. Pat. No. 4,814,087, a fuel delivery system is known in which a separator module is provided between a fuel tank and the combustion engine, the separator module separating water or particles contained in the fuel. This separator module, while enhancing the quality of the fuel conducted to the engine, does not eliminate the heterogeneous mixture components in the combustion mixture to a sufficient degree.

In addition, a method for separating aromatic hydrocarbons from a hydrocarbon mixture is known from U.S. Pat. No. 5,039,418, where aromatic hydrocarbons are separated with the aid of pervaporation at a membrane on the basis of an oxazolidone. To this end, the side of the membrane that faces away from the conveyed hydrocarbon mixture is acted upon by vacuum pressure and the aromatics-enriched mixture is condensed out.

It is an objective of the present invention to provide a method and a device for obtaining a fuel that will result in an at least partially homogenized combustion mixture in the combustion chamber of a combustion engine, thereby reducing the particle and nitrogen-oxide emission of the engine.

### SUMMARY OF THE INVENTION

The objective on which the present invention is based is attained in an advantageous manner by the method and the device of the present invention. For this purpose, the provided fuel is fractioned outside the combustion chamber of an engine at a separation means, such as a membrane. The side of the membrane facing away from the supplied fuel is acted upon by a scavenging gas, in particular by air or an oxygen-containing gas mixture, such as a combustion waste gas. In an advantageous manner, this makes it possible to dispense with the use of vacuum pressure on the permeate side of the membrane. The air enriched with the fuel permeate, or the correspondingly enriched, oxygen-rich gas mixture, is conveyed to the combustion engine as component of the combustion air.

Preferably, the permeating fuel fraction contains hardly combustible, aromatics-enriched fuel fractions. The particular advantage of separating hardly combustible, aromatics-enriched fuel fractions from a fuel and their supply into the combustion chamber via the combustion air is that the hardly combustible fuel fractions, which tend to form soot, then reach the combustion chamber already in gaseous or vapor form. Therefore, the fuel-air mixture conveyed to the combustion chamber in this manner is present in approximately completely homogenous form and the formation of heterogeneous mixture components is avoided.

In an advantageous manner, the membrane is acted upon by air or by an oxygen-rich gas mixture on the permeate side at normal pressure or overpressure. This simplifies the design of the fuel-supply unit, since it is possible to dispense with a vacuum-device.

In another advantageous specific embodiment, a capacitor or an accumulating material is disposed downstream from the separator module containing the membrane, which extracts from the scavenging gas the fuel fractions picked up at the membrane and stores them temporarily. In this manner, a store of fuel permeate may be produced.

It is advantageous, furthermore, if the scavenging gas that acts upon the membrane is carried at least intermittently in a closed circuit that has a capacitor or an accumulating material. In this way, it is possible to operate the fractioning unit in an advantageous manner even at times when the associated combustion engine is not in operation or when it would be disadvantageous to operate it using pre-fractioned fuel.

In an especially advantageous specific embodiment, the fractioning unit has one or two bypass(es), making it possible to supply at least a portion of the fuel or the scavenging gas directly to the combustion engine, bypassing the membrane unit. In this manner, the conversion within the membrane unit may be regulated independently of the rate of fuel or the air flow rate of the internal combustion engine.

### BRIEF DESCRIPTION OF THE DRAWINGS

FIG. 1 shows a schematic representation of a fuel-supply unit according to a first exemplary embodiment.

FIG. 2 and FIG. 3 show schematized representations of fuel-supply units according to two additional exemplary embodiments.

### DETAILED DESCRIPTION

The fundamental design of a fuel-supply unit according to the present invention is described in the following. Fuel-supply unit 10 includes a separator module 12, which has a first cavity 14 and a second cavity 16. Cavities 14, 16 are separated from one another by a separation means 18. Separation means 18 is preferably embodied as a membrane, but it may also be a porous material that acts as a filter or it may be a molecular sieve.

A fuel, in particular a diesel fuel, is conducted to separator module 12 via a first supply line 20. For this purpose, first supply line 20 may be connected, for example, to a fuel tank, which is not shown. It is also possible that first supply line 20 is in connection with a fuel-return line (not shown), via which not injected fuel is returned from a combustion engine 24 to the fuel tank. In this way, fuel that has already been heated to approximately 80 degrees Celsius is conveyed to first cavity 14 via first supply line 20.

Inside separator module 12, the fuel conveyed via first supply line 20 is subjected to fractionation. By way of a first outlet line 22, the fractioned fuel is withdrawn from separator module 12 and preferably conveyed to combustion engine 24 or the fuel tank. Combustion engine 24 has a third outlet line 29 for diverting combustion waste gases.

Separator module 12 has a second supply line 26 via which a scavenging gas is conducted to second cavity 16 of separator module 12. This scavenging gas is air, for example, or some other oxygen-containing gas mixture. It is supplied to second cavity 16 preferably under normal pressure or superpressure. The supply at a slight vacuum pressure up to approximately 900 hPa is also possible.

In contact with separation means 18, the scavenging gas absorbs fuel fractions in vapor or gaseous form inside second cavity 16 and leaves separator module 12 via a second outlet line 28. Second outlet line 28 is preferably embodied as intake line for combustion air or as component of the air supply of combustion engine 24.

Supply lines 20, 26 or separator module 12 have a heating device, for instance, to heat up the fuel or the scavenging gas conveyed to separator module 12, the fuel being heated to temperatures of between 80 and 180 degrees Celsius, preferably to 160 degrees Celsius. This is an electric heating device, for example.

Separator module 12 includes a separation means 18 by which separator module 12 is subdivided into a first cavity 14 and a second cavity 16. Separation means 18 is preferably embodied as membrane. The membrane material is selected such that only selected fuel fractions in vapor or gaseous form may get from first cavity 14 into second cavity 16 by way of pervaporation. Pervaporation is understood to be a process in which a vapor mixture that forms above a fluid mixture is separated at a suitable membrane due to different permeabilities.

A polymer, for example, which allows passage only to high-boiling or hardly ignitable fuel fractions, is selected as material for the membrane. The separation effect of the membrane is based, in particular, on the solubility of the fuel fractions to be separated in the material of the membrane. Membranes on the basis of polymer oxazolidones, for example, such as they are described in U.S. Pat. No. 5,039,418, for instance, membranes on the basis of cross-linked polyesteramides, as they are described in European Patent No. EP 456 686, or preferably membranes on the basis of polyimides, according to the present invention, are suitable for separating aromatic fuel fractions.

The ignition performance of diesel fuels, for example, is generally described by the so-called cetane number. The lower the cetane number of a fuel components, the lower its ignition performance.

Furthermore, fuel supply unit 10 has a first bypass 30, which, for example, connects first supply line 20 to first outlet line 22 while bypassing first cavity 14 of separator module 12. If first supply line 20 is provided with a three-way valve (not shown) at the branching point of first bypass 30, it is possible to meter the fuel quantity supplied to separator module 12 independently of the fuel quantity supplied to combustion engine 24 or a fuel tank.

Furthermore, fuel supply unit 10 preferably has a second bypass 32, which connects second supply line 26 to second outlet line 28 while bypassing second cavity 16 of separator module 12. If another three-way valve (not shown) is integrated in second supply line 26 at the branching point of bypass 32, the scavenging gas quantity supplied to second cavity 16 may be controlled independently of the scavenging gas quantity conducted to combustion engine 24.

During operation, a fuel, such as diesel, gasoline, an alcohol mixture or heating oil, is conveyed in first cavity 14 via first supply line 20. The supplied fuel preferably has a temperature of approximately 80 to 180 degrees Celsius, preferably 160 degrees Celsius when high-boiling fuels such as diesel are involved.

If necessary, the fuel is preheated by a heating device (not shown) before it enters first cavity 14. If it is a fuel that is conveyed to the fuel tank via a return line, it is usually already preheated and additional preheating will not be necessary. In first cavity 14, the supplied fuel comes into contact with membrane 18. In doing so, preferably aromatic fuel fractions detach in the material of membrane 18 and reach the permeate side of the membrane. Second cavity 16 is acted upon by a scavenging gas via second supply line 26. The scavenging gas may consist of air or another suitable oxygen-containing gas mixture, such as air mixed with waste gases of combustion engine 24 or mixed with cathode waste gases of fuel cells.

As an alternative, separator module 12 may be designed in the form of a so-called hollow fiber module. In one possible embodiment, the scavenging gas flows around a bundle of polymer hollow fibers in which the fuel to be fractioned is conducted.

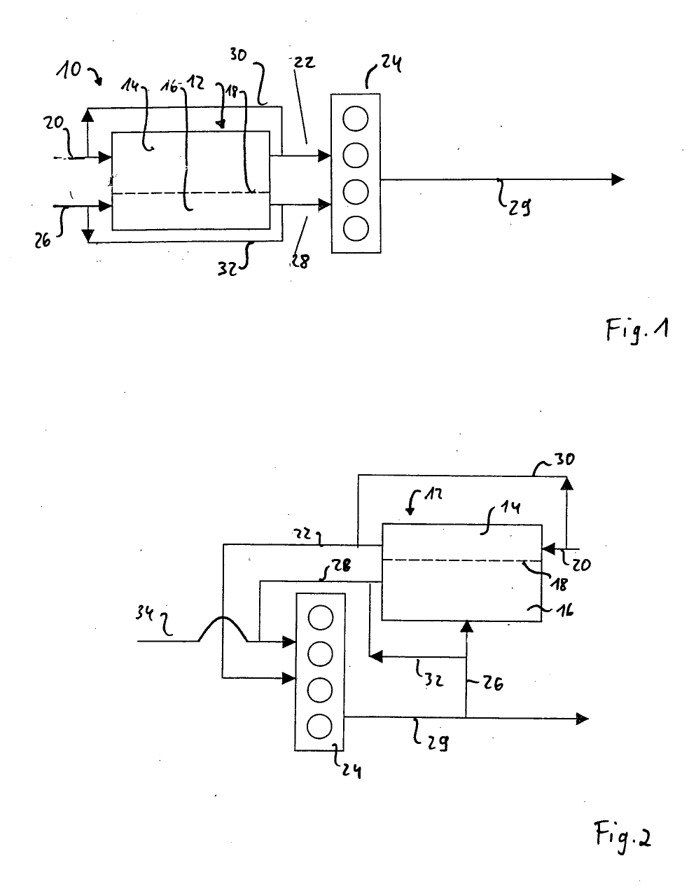

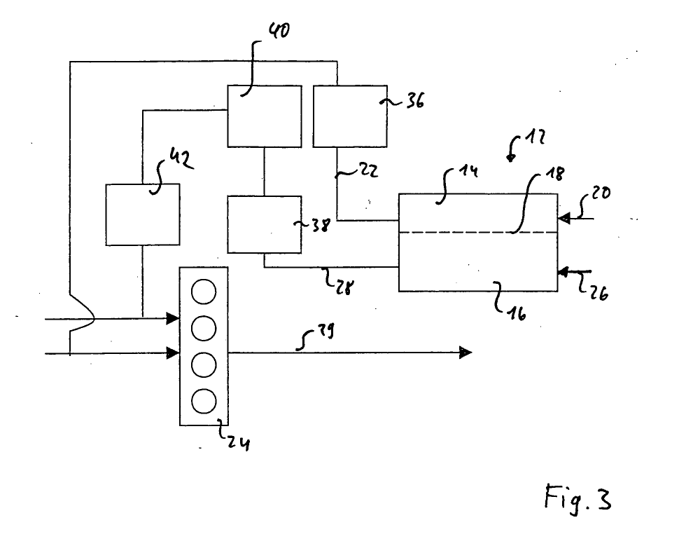

FIG. 2 depicts an additional exemplary embodiment of the present invention. Identical reference numerals denote the same device components as in FIG. 1. The fuel supply unit illustrated in FIG. 2 has a third outlet line 29 having a branch via which the combustion waste gases of combustion engine 24 may be taken out. The combustion waste gases taken out are conducted to separator module 12 by way of second supply line 26. The second supply line is preferably connected to second outlet line 28 by a bypass 32, as shown in FIG. 1. The scavenging gas in the form of a returned waste gas, enriched with fuel fractions and conducted in second outlet line 28, is mixed with the combustion air conveyed via a third supply line 34 and conducted to combustion engine 24.

In contrast to a heretofore described continuous operating mode of separator module 12, a discontinuous operating mode is also conceivable. For example, the fractioning of the fuel at separation means 18 may be prevented by interrupting the supply of scavenging gas to second cavity 16 of separator module 12. The fuel is then still able to pass through first cavity 14 of separator module 12, but it reaches the combustion chambers of combustion engine 24 unchanged. Such an operating mode may be required in the case of certain combustion characteristics.

An additional discontinuous operating mode is the basis of the further exemplary embodiment of the present invention represented in FIG. 3. As before, identical reference numerals denote the same device components as in FIG. 1. In the fuel supply unit shown in FIG. 3, a first storage tank 36 in which the fuel retentate produced in separator module 12 may be stored temporarily is provided as part of first outlet line 22. This allows storing a fuel that, at least in part, has been freed of hardly combustible, aromatic or high-boiling components and thus results in a largely low-emission operating mode, in particular during start phases and low-load phases of a combustion engine.

Furthermore, a capacitor 38 is integrated in second outlet line 28 via which the fuel contained in the scavenging gas, which is enriched with gaseous or vapor fuel fractions, may be withdrawn by condensation, and the resultant gas-fluid mixture be conducted to a second storage tank 40. Second storage tank 40 may be in connection with an evaporator-metering unit 42, which thereby allows charging the combustion air of combustion engine 24 or the recycled exhaust gases with hardly combustible, aromatics-enriched or high-boiling fuel fractions.

Alternatively to capacitor 38, a module having an accumulator material may be provided in second outlet line 28 to store the fuel fractions contained in the scavenging gas. It is constructed from zeolite, for example, and releases the stored fuel to the scavenging gas again in response to external heating. Both capacitor 38 in connection with second storage tank 40 and evaporator-metering unit 42, and also the alternative module having an accumulating material allow the storing of hardly ignitable, aromatics-enriched or high-boiling fuel components. These may preferably be conducted to combustion engine 24 in a suitable operating mode, such as during full-load operation.

The fuel supply unit according to the present invention or the method for operating the same are not limited in their application to the operation in connection with combustion engines of motor vehicles, which, among others, may also have a fuel cell as auxiliary power unit. Instead, the fuel supply unit may also be used to supply liquid or gaseous fuels to be used in turbines, especially in the power plant field.

In systems that have a fuel cell, for example as auxiliary power unit (APU) in addition to a combustion engine 24, the fuel retentate produced in separator module 12 may in one advantageous specific embodiment be supplied, at least intermittently, to a reformer of the fuel cell. The advantage of such an arrangement is that aromatics-enriched fuels may be converted into hydrogenous gas mixtures much more efficiently.

What is claimed is:

1. A method for supplying a fuel, comprising:
splitting-up the fuel at a separation device into a first fuel fraction in the form of a retentate and into a second fuel fraction in the form of a permeate; and
acting upon the separation device by a scavenging gas on a permeate side, so that a mixture of a fuel permeate and the scavenging gas is produced.

2. The method according to claim 1, wherein the fuel is supplied for operating one of a combustion engine in a motor vehicle and a turbine.

3. The method according to claim 1, wherein the fuel is fractioned into a fuel retentate and a fuel permeate by pervaporation at a membrane.

4. The method according to claim 1, wherein, using a membrane, the fuel is fractioned into a fuel retentate having at least one of a first centane number and a first boiling point, and a fuel permeate having at least one of a second centane number and a second boiling point, wherein at least one of (a) the second centane number is lower than the first centane number and (b) the second boiling point is lower than the first boiling point.

5. The method according to claim 1, wherein, on the permeate side, a membrane is acted upon by one of air and an oxygen-containing gas mixture as scavenging gas under one of normal pressure and superpressure.

6. The method according to claim 1, further comprising:
conducting the scavenging gas at least intermittently in a closed circuit;
bringing the scavenging gas into contact with a membrane; and
separating fuel components contained therein downstream in a fuel direction.

7. The method according to claim 1, further comprising, following contact with a membrane, conducting the scavenging gas via a capacitor at which fuel components contained in the scavenging gas are separated.

8. The method according to claim 1, further comprising, following contact with a membrane, conducting the scavenging gas via an accumulator material at which fuel components contained in the scavenging gas are stored temporarily.

9. The method according to claim 1, further comprising charging the scavenging gas with waste gases of one of a combustion engine, a turbine and a fuel cell.

10. The method according to claim 1, wherein the scavenging gas is made up of waste gases of one of a combustion engine, a turbine and a fuel cell.

11. A device for supplying a fuel for a combustion engine in a motor vehicle, comprising:
a separator module having a first cavity and a second cavity, the first cavity being provided with a supply line for the supply of the fuel and an outlet line for fractioned fuel, the second cavity being separated from the first cavity by a separation device, the second cavity having a supply line for a scavenging gas and an outlet line for the scavenging gas loaded with at least one fuel component.

12. The device according to claim 11, wherein the outlet line for the scavenging gas loaded with at least one fuel component is connected to at least one of an air intake and an injection system of a downstream combustion engine.

13. The method according to claim 11, wherein the outlet line for fractioned fuel is connected to a reformer of a fuel-cell system.

14. The method according to claim 1, wherein one of the separator module and the supply line for the scavenging gas includes a heating device.

15. The method according to claim 11, wherein the separation device includes a membrane made of a material in which a permeation of fuel components is implemented in relation to a solubility in a membrane material.

16. The method according to claim 11, further comprising a membrane composed of a material in which a permeation of aromatic fuel components occurs.

17. The method according to claim 11, wherein the supply line for the supply of the fuel and the outlet line for fractioned fuel are connected to at least one of a bypass and the supply line for the scavenging gas, and the outlet line for the scavenging gas loaded with the at least one fuel component are connected by an additional bypass.

18. The method according to claim 11, wherein the first cavity and the second cavity, together with a membrane, are in the form of a hollow-fiber module.

19. A membrane material for separating components of a hydrocarbon mixture, comprising:
a polyimide for separating aromatic fractions of a fuel.
